(19) United States
(12) Patent Application Publication
(10) Pub. No.: US 2026/0228679 A1
(43) Pub. Date: Aug. 6, 2026

(54) Information Processing System, Information Processing Method, and Product Shipping System

(71) Applicants: HOKKAIDO ELECTRIC POWER CO., INC., Chuo-ku, Sapporo-shi, Hokkaido (JP); HITACHI, LTD., Chiyoda-ku, Tokyo (JP)

(72) Inventors: Mamoru OKAMOTO, Tokyo (JP); Takashi TAKEMOTO, Tokyo (JP); Takafumi IBARAKI, Tokyo (JP); Keisuke TERADA, Tokyo (JP); Nobuhiro WATANABE, Hokkaido (JP); Kiyotaka MATSUURA, Hokkaido (JP); Sayuri ONO, Hokkaido (JP)

(21) Appl. No.: 19/159,164

(22) PCT Filed: Feb. 28, 2023
(86) PCT No.: PCT/JP2023/007384

§ 371 Date: Aug. 22, 2025

(51) Int. Cl. G06Q 10/083

(52) U.S. Cl. CPC G06Q 10/08355

(57) ABSTRACT

An information processing system including: an acceptance unit that accepts, when shipping a product produced by a shipper including a plant factory to a delivery destination, confirmed shipment information which is confirmed information about shipment of the product, and purchase application information which is information of an application for purchase of the product by the delivery destination; and a processing unit that decides the delivery destination of the product by performing sale-and-purchase matching, based on predetermined optimization criteria, to make the confirmed shipment information and the purchase application information match each other in order of priority. Consequently, when the plant factory is included as the shipper, it is possible to improve a facility operating rate of the plant factory and reduce disposal of the product.

### TECHNICAL FIELD

The present invention relates to an information processing system, an information processing method, and a product shipping system. Particularly, the present invention relates to, for example, an information processing system which can be preferably used when shipping products from a shipper(s) including a plant factory/factories to a delivery destination.

### BACKGROUND ART

Food is produced by plant factories in order to achieve stable food production in consideration of, for example, shortage of agricultural producers in future and their sale to and direct dealings with wholesale markets are conducted.

PTL 1 discloses a production management system including: a management unit that manages at least information of air temperature detected as changes of a growing environment of agricultural products; and a yield prediction unit that predicts a yield of the agricultural products based on a model indicating a photosynthesis amount of the agricultural products with respect to the air temperature and a model indicating a growth amount of the agricultural products with respect to the air temperature.

### CITATION LIST

### Patent Literature

PTL 1: Japanese Patent Application Laid-Open (Kokai) Publication No. 2020-24703

### SUMMARY OF THE INVENTION

### Problems to be Solved by the Invention

Pesticide-free and environmental burden reduction can be listed as advantageous effects of plant factories other than the stable production.

However, the current situation is that the plant factories are disadvantageous as compared to the open-field cultivation in terms of costs. Therefore, it is important to more efficiently make use of the products produced at the plant factories. On the other hand, it is difficult to predict the demand for, or sell out, the products of the plant factories, so that it is difficult to improve a facility operating rate of the plant factories, which may sometimes become a factor of an increase of product prices.

It is an object of the present invention to provide an information processing system, an information processing method, and a product shipping system which are capable of improving the facility operating rate of the plant factories and reduce disposal of the products when the plant factories are included as shippers.

### Means to Solve the Problems

In order to solve the above-described problems, the present invention is an information processing system including: an acceptance unit that accepts, when shipping a product produced by a shipper including a plant factory to a delivery destination, confirmed shipment information which is confirmed information about shipment of the product, and purchase application information which is information of an application for purchase of the product by the delivery destination; and a processing unit that decides the delivery destination of the product by performing sale-and-purchase matching, based on predetermined optimization criteria, to make the confirmed shipment information and the purchase application information match each other in order of priority. In this case, it is possible to provide the information processing system capable of improving the facility operating rate of the plant factory and reducing the disposal of the product.

Under this circumstance, the sale-and-purchase matching can be decided for each product and can be performed by using a sale-and-purchase match graph which couples a shipper node decided by the confirmed shipment information and a consumer node decided by the purchase application information with a directed edge corresponding to a logistics route).

In this case, the sale-and-purchase matching becomes much easier.

Moreover, the sale-and-purchase matching can be processing for solving a multi-commodity minimum cost flow problem based on the sale-and-purchase match graph. In this case, the sale-and-purchase matching can be performed more accurately.

Furthermore, the sale-and-purchase matching can be processing for scalarizing the optimization criteria to create an objective function and solving the multi-commodity minimum cost flow problem on the sale-and-purchase match graph with respect to the created objective function. In this case, the multi-commodity minimum cost flow problem can be solved much faster.

Furthermore, the sale-and-purchase match graph can be created for each preset rank with respect to the delivery destination. In this case, the product can be allocated preferentially to a high-ranking delivery destination.

Moreover, an edge selected based on the optimization criteria, as one which does not become Pareto inferior, in a logistics graph formed by coupling logistics bases with a directed edge corresponding to a logistics route can be used as the directed edge to be used in the sale-and-purchase match graph. In this case, a more appropriate edge can be used as an effective edge.

Furthermore, the directed edge of the logistics graph can represent information about the logistics route. In this case, a more appropriate logistics route is found as a solution.

Furthermore, the sale-and-purchase matching can be performed to implement matching so as not to exceed an allowable shipping fee which is an upper limit of a shipping fee. In this case, the sale-and-purchase matching can be performed in consideration of the upper limit of the shipping fee.

Then, the processing unit can propose adjustment of a type of the product produced at the plant factory based on shipment schedule information which is scheduled information about shipment of the product and the purchase application information. In this case, it is possible to further improve the facility operating rate of the plant factory and reduce the disposal of the product.

Moreover, the processing unit can propose the adjustment of the type of the product produced at the plant factory by performing a matching procedure to cause matching based on the shipment schedule information and the purchase application information according to the optimization criteria. In this case, the accuracy in adjusting the type of the product is improved.

Furthermore, the matching procedure can be processing for tentatively creating a quantity of the product to be shipped by the plant factory based on a result of the matching between the shipment schedule information and the purchase application information and making the shipment schedule information, which has been corrected by incorporating the tentatively created shipment schedule, and the purchase application information match each other. In this case, it is possible to propose the production adjustment by estimating even the quantity of the product to be shipped after the production adjustment.

Furthermore, criteria relating to logistics of the product can be set as the optimization criteria.

In this case, it is possible to make the logistics of the product more efficient.

Then, the shipper can include an outlet distributor. In this case, it is possible to reduce the disposal of the product also with respect to the outlet business operator.

Moreover, the present invention is an information processing method including the following, by execution of software recorded in a memory by a processor: accepting, when shipping a product produced by a shipper including a plant factory to a delivery destination, confirmed shipment information which is confirmed information about shipment of the product, and purchase application information which is information of an application for purchase of the product by the delivery destination; and deciding the delivery destination of the product by performing sale-and-purchase matching, based on predetermined optimization criteria, to make the confirmed shipment information and the purchase application information match each other in order of priority. In this case, it is possible to provide the information processing method capable of improving the facility operating rate of the plant factory and reducing disposal of the product.

Furthermore, the present invention is a product shipping system including: a first terminal device to which a shipper including a plant factory inputs information about a product when shipping the product produced by the shipper to a delivery destination; a second terminal device to which the delivery destination inputs purchase application information that is information of an application for purchase of the product; and an information processing system that decides the delivery destination of the product produced by the shipper, wherein the information processing system includes: an acceptance unit that accepts confirmed shipment information which is confirmed information about shipment of the product, and the purchase application information; and a processing unit that decides the delivery destination of the product by performing sale-and-purchase matching, based on predetermined optimization criteria, to make the confirmed shipment information and the purchase application information match each other. In this case, it is possible to make the logistics of the product more efficient.

### Advantageous Effects of the Invention

According to the present invention, it is possible to provide the information processing system, the information processing method, and the product shipping system which can enhance the facility operating rate of the plant factories and reduce the disposal of the products when the plant factories are included as shippers.

### BRIEF DESCRIPTION OF DRAWINGS

FIG. 1 is a diagram illustrating a schematic configuration of a product shipping system according to this embodiment;

FIG. 2 is a block diagram illustrating a functional configuration of the product shipping system;

FIG. 3 is a sequence diagram explaining the outline of operations of the product shipping system;

FIG. 4 is a flowchart illustrating a shipper registration procedure;

FIG. 5 is a flowchart for explaining the details of a product registration request procedure performed when making a product registration request as indicated in step S405 in FIG. 4;

FIG. 6 is a flowchart illustrating a consumer registration procedure;

FIG. 7 is a flowchart illustrating a shipment schedule registration procedure;

FIG. 8 is a flowchart illustrating a shipment schedule notification procedure;

FIG. 9 is a flowchart illustrating a purchase application acceptance procedure;

FIG. 10 is a flowchart illustrating a product purchase confirmation procedure;

FIG. 11 is a flowchart illustrating operations of a sale-and-purchase matching device;

FIG. 12 is a flowchart illustrating a confirmed shipment registration procedure;

FIG. 13 is a diagram illustrating shipper information saved in a shipper DB;

FIG. 14 is a diagram illustrating consumer information saved in a consumer DB;

FIG. 15 is a diagram illustrating shipment schedule information saved in a shipment schedule DB;

FIG. 16 is a diagram illustrating confirmed shipment information saved in a confirmed shipment DB;

FIG. 17 is a diagram illustrating purchase application information saved in a purchase application DB;

FIG. 18 is a diagram illustrating confirmed purchase information saved in a confirmed purchase DB;

FIG. 19 is a diagram illustrating product information saved in a product DB;

FIG. 20(a) and (b) are diagrams illustrating logistics route information saved in a logistics DB;

FIG. 21 is a flowchart for explaining production type adjustment of a product(s) to be performed with respect to a plant factory;

FIG. 22 (a) and (b) are diagrams explaining sale-and-purchase matching; and

FIG. 23 is a flowchart for explaining further details of operations of the sale-and-purchase matching device when matching processing is performed.

### <Overall Explanation of Product Shipping System 1>

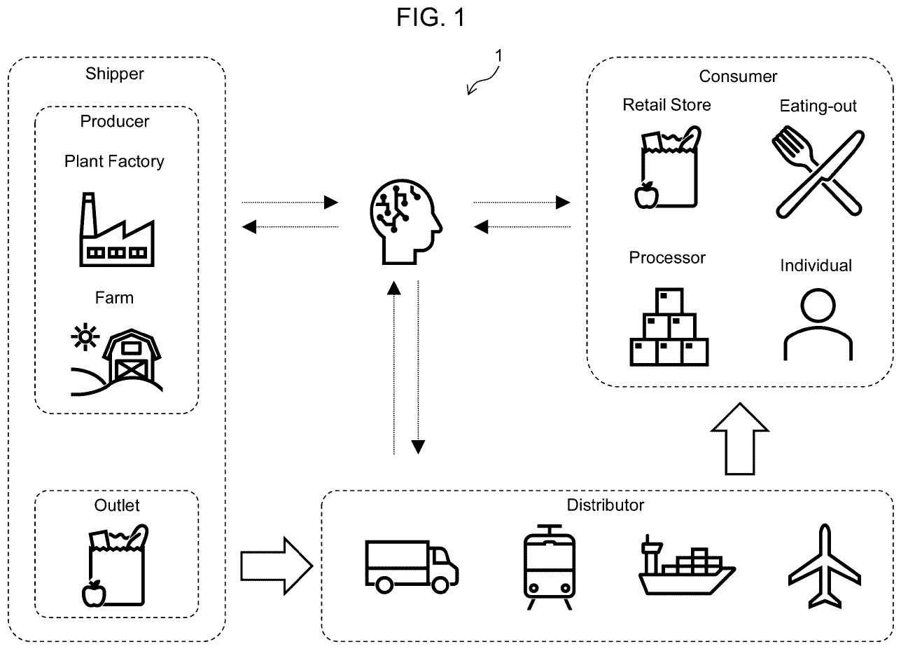

FIG. 1 is a diagram illustrating a schematic configuration of a product shipping system 1 according to this embodiment.

The product shipping system 1 illustrated in FIG. 1 shows a case where products are transported from shippers to consumers.

The “shipper(s)” is a shipping source(s) of products and is a person who serves a role to supply the products. Here, plant factories and farms which perform open-field cultivation are shown as examples of the shippers. Moreover, in this embodiment, the shippers include an outlet distributor(s). Incidentally, the products are food. Cultivated types of products produced at plant factories are, for example, leaf vegetables in general (such as leaf lettuce, herbs, and baby leaves), and strawberries.

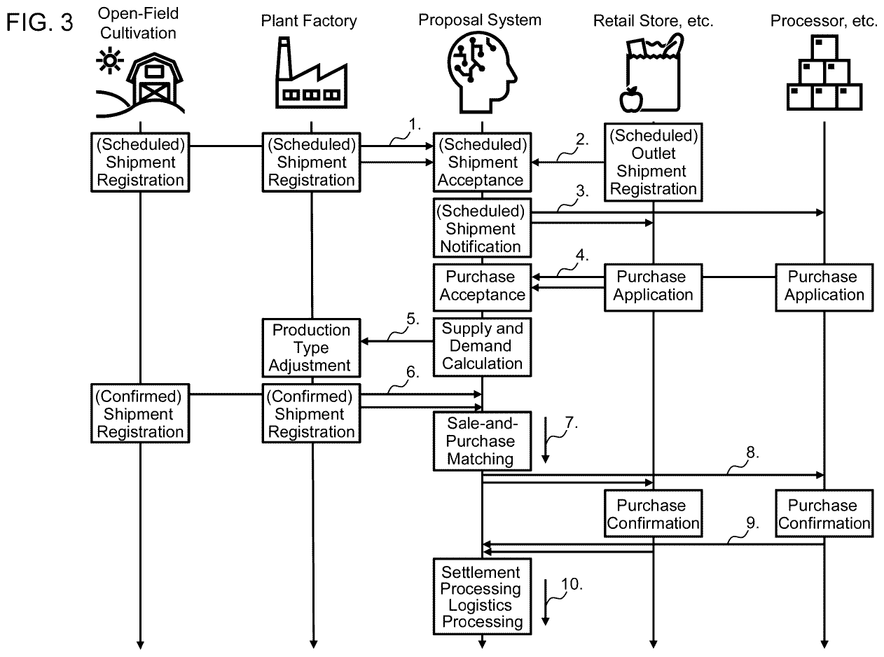

The “consumer(s)” is an example of the delivery destination of a product and is a person who takes the role of consuming food that is the product. The consumer has the purpose of purchasing the product. Here, retail stores, eating-out industries such as restaurants, processors of food, and individuals are shown as examples of the consumers. Incidentally, an outlet distributor(s) may be a retail store(s) as indicated in FIG. 3 described later. Specifically speaking, the outlet distributor(s) may be sometimes both the shipper(s) and the consumer(s).

The product is transported by a distributor(s). Here, a distributor(s) who transports the product using trucks, railways, ships, and airplanes are shown as the distributor(s).

In this embodiment, the shippers, the consumers, and the distributors are connected, and the consumer to whom the product produced by the shipper is to be shipped is determined.

Consequently, this realizes, for example, an information processing system capable of improving the facility operating rate of the plant factory and reducing the disposal of the product.

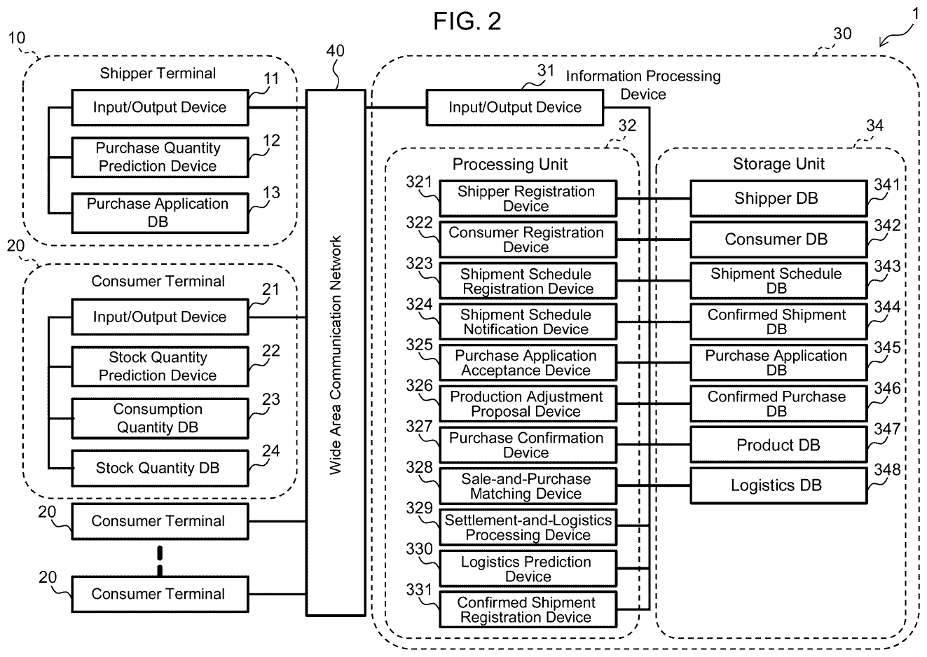

FIG. 2 is a block diagram illustrating a functional configuration of the product shipping system 1.

The product shipping system 1 illustrated in the diagram is configured such that a shipper terminal 10 which is an example of a first terminal device, a consumer terminal 20 which is an example of a second terminal device, and an information processing device 30 which is an example of an information processing system are connected via a wide area communication network 40.

Incidentally, in FIG. 2, there is one shipper terminal 10 and there are a plurality of consumer terminals 20, but there may be any number of each of such terminals.

The shipper terminal 10 is a terminal device to which the shipper(s) including a plant factory/factories inputs information about products when shipping their produced products to the delivery destination.

The consumer terminal 20 is a terminal device to which the delivery destination inputs purchase application information that is information of an application for the purchase of the products.

The shipper terminal 10 and the consumer terminal 20 are, for example, computer devices such as PCs (Personal Computers), mobile computers, smart phones, and tablets.

The information processing device 30 is, for example, a server computer and manages the entire product shipping system 1. In this embodiment, the details will be described later, but the information processing device 30 decides the delivery destination of the products produced by the shipper.

Each of the shipper terminal 10, the consumer terminal 20, and the information processing device 30 includes a processor such as a CPU (Central Processing Unit) which is an arithmetic means, and storage such as a main memory and an HDD (Hard Disk Drive) which are storage means. The processor herein used executes various kinds of software such as an OS (basic software) and application programs (application software). Moreover, the main memory is storage areas for storing, for example, various kinds of software and data to be used to execute the software. Furthermore, the storage is storage areas for storing, for example, input data for the various kinds of software and output data from the various kinds of software.

Each of the shipper terminal 10, the consumer terminal 20, and the information processing device 30 includes a communication interface (hereinafter written as a “communication I/F”) for communicating with the outside, a display mechanism composed of a video memory, a display, etc., and an input mechanism such as a keyboard and a mouse.

The wide area communication network 40 is communication means used for information communication between the shipper terminal 10, the consumer terminal 20, and the information processing device 30 and is, for example, the Internet, a LAN (Local Area Network), or a WAN (Wide Area Network). Communication lines used for data communication may be either wired or wireless and both of them may be used together.

Moreover, the shipper terminal 10, the consumer terminal 20, and the information processing device 30 may by connected via a plurality of networks and communication lines by using relay devices such as gateway devices and routers.

### <Description of Operations of Product Shipping System 1>

FIG. 3 is a sequence diagram for explaining the outline of operations of the product shipping system 1.

FIG. 3 illustrates processing performed between producers indicated as open-field cultivation and a plant factory, the information processing device 30 indicated as a proposal system, and consumers indicated as a retail store, etc., and a processor, etc. Under this circumstance, the product shipping system 1 operates by performing each processing from 1 to 10. An explanation will be provided below about each processing from 1 to 10.

1. Firstly, the producers indicated as the open-field cultivation and the plant factory register a product shipment schedule. FIG. 3 shows this as (scheduled) shipment registration. The producers register, as the product shipment schedule, for example, a scheduled production quantity, a scheduled shipping date, and a shipping price. The product shipment schedule is accepted as (scheduled) shipment acceptance by the information processing device 30 indicated as the proposal system.

2. When a retail store, etc. is the outlet distributor, the outlet distributor sometimes registers the shipment schedule as the producer. FIG. 3 shows this as a (scheduled) outlet shipment registration. The outlet distributor registers, as the product shipment schedule, for example, a scheduled sales quantity, a shipping date, and a shipping price of an outlet product.

3. The information processing device 30 indicated as the proposal system notifies the consumers of the product shipment schedule. FIG. 3 shows this as a (scheduled) shipment notification. The information processing device 30 reports, as the product shipment schedule, for example, the scheduled sales quantity, the scheduled shipping date, and the shipping price. Under this circumstance, the information processing device 30 may report a product of the open-field cultivation and a product of the plant factory by distinguishing between them. Accordingly, it is possible to emphasize that the product of the plant factory is a branded item.

4. The consumer indicated as the retail store, etc., or the processor, etc., applies for the purchase of the product. FIG. 3 shows this as a purchase application. The consumer applies for, as the purchase application, for example, a production type which is the type of the product, standards such as the size of the product, a purchase application price, a purchase application quantity, and a desired delivery date. Under this circumstance, the consumer may present a shipping fee or an allowable shipping fee which is an upper limit of the shipping fee. Then, the information processing device 30 indicated as the proposal system accepts the purchase as a procedure for accepting the purchase application.

5. The information processing device 30 indicated as the proposal system performs supply and demand computation between a production quantity of the product and its demand quantity. Then, the information processing device 30 proposes a production type adjustment of the product to the plant factory based on the supply and demand computation. The production type adjustment is performed by using the matching procedure which is an example of the matching processing.

The plant factory adjusts the production type of the product based on the proposal from the information processing device 30. Since the plant factory can flexibly switch the production type relatively easily, such adjustment is possible. Consequently, it is possible to improve the facility operating rate of the plant factory and reduce the disposal of the product.

6. The producer indicated as the open-field cultivation or the plant factory registers the product shipment confirmation. FIG. 3 shows this as (confirmed) shipment registration. The producer registers, as the shipment confirmation of the product, for example, a confirmed shipment quantity and a shipping date.

7. the information processing device 30 indicated as the proposal system performs sale-and-purchase matching to decide the delivery destination of the product produced by the producer. The sale-and-purchase matching is performed by using sale-and-purchase matching which is an example of the matching processing. Under this circumstance, the information processing device 30 can also perform sale-and-purchase matching with priority to decide the delivery destination according to preset rankings of the consumers.

8. The information processing device 30 indicated as the proposal system notifies the consumer of purchase confirmation of the product. The information processing device 30 reports, as the product purchase confirmation, for example, a purchase quantity, a purchase price, a delivery date, and a shipping fee. 9. The consumer indicated as the retail store, etc., or the processor, etc., performs a purchase confirmation procedure based on this notice. 10. The information processing device 30 indicated as the proposal system performs settlement processing and logistics processing.

Next, returning back to FIG. 2, the detailed explanation will be provided about the shipper terminal 10, the consumer terminal 20, and the information processing device 30.

### <Detailed Description of Shipper Terminal 10>

The shipper terminal 10 includes an input/output device 11, a purchase quantity prediction device 12, and a purchase application DB (database) 13.

The input/output device 11 is a device which corresponds to the aforementioned input mechanism and output mechanism and is for the shipper to input and display the information about the shipment of the product. Specifically, the shipment schedule information and the confirmed shipment information are input. The shipment schedule information is information scheduled for the shipment of the product. Then, the confirmed shipment information is confirmed information about the shipment of the product when shipping the product produced by the shipper including the plant factory to the delivery destination.

Moreover, the input/output device 11 corresponds to the aforementioned communication I/F and sends/receives information to/from the information processing device 30.

The purchase quantity prediction device 12 corresponds to the aforementioned processor and predicts a purchase quantity of the product to be purchased by the consumer. The purchase quantity prediction device 12 performs the prediction based on, for example, the product type purchased by the consumer at the same time period in the past and a history of the purchase quantity. If the shipper is a plant factory, it is possible to decide, for example, cultivated varieties to be produced, their shipping seasons, and their shipment quantity based on the prediction by the purchase quantity prediction device 12.

The purchase application DB 13 corresponds to the aforementioned storage and saves the purchase application information of the consumer. The purchase application information is information of an application for the purchase of the product by the delivery destination.

### <Detailed Explanation of Consumer Terminal 20>

The consumer terminal 20 includes an input/output device 21, a stock quantity prediction device 22, a consumption quantity DB 23, and a stock quantity DB 24.

The input/output device 21 corresponds to the aforementioned input mechanism and output mechanism and is a device for the consumer to input and display information about the purchase of the product. Moreover, the input/output device 21 corresponds to the aforementioned communication I/F and sends/receives information to/from the information processing device 30.

The stock quantity prediction device 22 corresponds to the aforementioned processor and predicts a stock quantity of the product possessed by the consumer. The stock quantity prediction device 22 predicts the stock quantity of the product based on, for example, a consumption quantity of the product consumed in the same time period in the past or a purchase plan of the product.

The consumption quantity DB 23 corresponds to the aforementioned storage and saves a history of the consumption quantity of the consumed product.

The stock quantity DB 24 corresponds to the aforementioned storage and saves a history of the stock quantity of the product possessed by the consumer.

### <Detailed Description of Information Processing Device 30>

The information processing device 30 includes an input/output device 31, a processing unit 32, and a storage unit 34.

The input/output device 31 is an example of the acceptance unit. The input/output device 31 corresponds to the aforementioned input mechanism and output mechanism and is a device for the information processing device 30 to accept and display the information about the product. Moreover, the input/output device 31 corresponds to the aforementioned communication I/F and sends/receives the information to/from the shipper terminal 10 and the consumer terminal 20.

The processing unit 32 corresponds to the aforementioned processor and executes each processing performed by the information processing device 30.

The storage unit 34 corresponds to the aforementioned storage and saves various kinds of information about the shipper(s), the consumer(s), the product(s), and the logistics regarding the product(s).

The processing unit 32 includes a shipper registration device 321, a consumer registration device 322, a shipment schedule registration device 323, a shipment schedule notification device 324, a purchase application acceptance device 325, a production adjustment proposal device 326, a purchase confirmation device 327, a sale-and-purchase matching device 328, a settlement-and-logistics processing device 329, a logistics prediction device 330, and a confirmed shipment registration device 331. Incidentally, these devices are illustrated here as devices, but they can be also mounted as software.

The shipper registration device 321 accepts information about the shipper from the shipper and performs a shipper registration procedure to register the shipper.

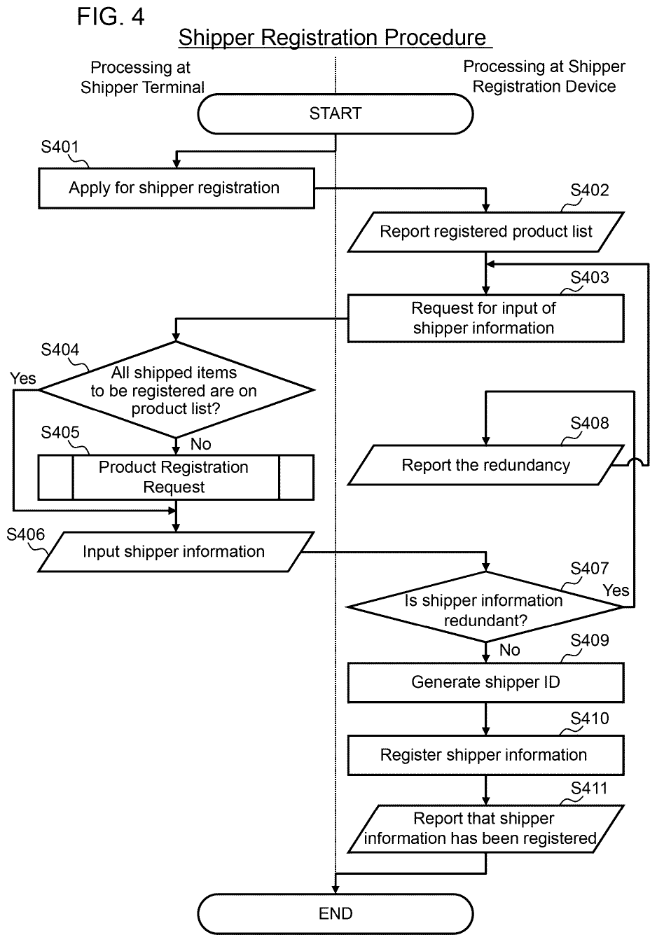

FIG. 4 is a flowchart illustrating the shipper registration procedure. Incidentally, FIG. 4 illustrates the flowchart separately for processing in the shipper terminal 10 and processing in the shipper registration device 321.

Firstly, the shipper applies for shipper registration (step S401).

Next, the shipper registration device 321 notifies the shipper of a list of registered products (step S402).

Moreover, the shipper registration device 321 requests the shipper to input the shipper information (step S403).

Then, the shipper judges whether all the shipped items to be registered are on the product list or not (step S404).

As a result, if at least some of the shipped items to be registered are not on the product list (step S404 (No), the shipper makes a product registration request (step S405). Then, the processing proceeds to the next step S406.

On the other hand, if all the shipped items to be registered are on the product list (Yes in step S404), the shipper inputs the shipper information (step S406). Values to be input by the shipper as the shipper information are, for example, the shipper name, their location, and a shipped item ID list.

The shipper registration device 321 accepts the input shipper information and judges whether the shipper information is redundant or not (step S407). The shipper registration device 321 judges the redundancy of the shipper information based on the shipper name and their location. Specifically, if there is a match regarding both the shipper name and their location, the shipper registration device 321 recognizes the redundancy.

As a result, if the shipper information is redundant (Yes in step S407), the shipper registration device 321 notifies the shipper of the redundancy (step S408). Then, the processing returns to step S403.

On the other hand, if the shipper information is not redundant (No in step S407), the shipper registration device 321 generates a shipper ID (step S409). The shipper registration device 321 generates a unique value as the shipper ID.

Furthermore, the shipper registration device 321 registers the shipper information (step S410).

Then, the shipper registration device 321 notifies the shipper that the shipper information has been registered (step S411).

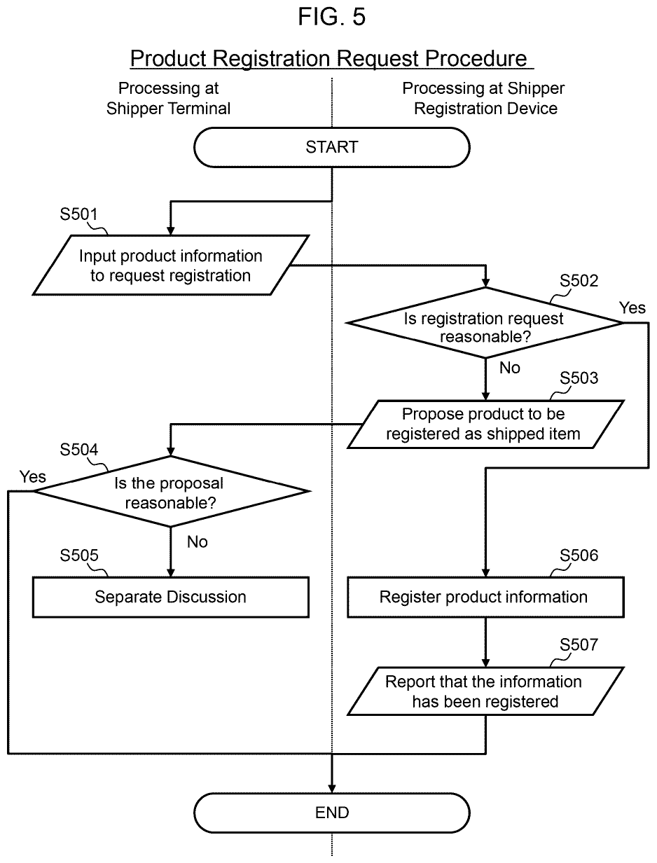

FIG. 5 is a flowchart for explaining the details of the product registration request procedure performed when making the product registration request as indicated in step S405 in FIG. 4.

Firstly, the shipper inputs product information to request the registration (step S501). The product information is information about the product which becomes necessary when shipping the product.

Next, the shipper registration device 321 judges whether the registration request is reasonable or not (step S502).

As a result, if the registration request is not reasonable (No in step S502), the shipper registration device 321 proposes a product to be registered as a shipped item (step S503). The information of the proposed product is sent to the shipper terminal 10 and the shipper judges whether the proposed product is reasonable or not (step S504).

Then, if it is reasonable (Yes in step S504), the series of processing is terminated. In this case, the shipper produces the proposed product.

On the other hand, if it is not reasonable (No in step S504), it is not possible to handle the matter within the product shipping system 1, so that it will be discussed separately (step S505).

Moreover, if the registration request is reasonable in step S502 (Yes in step S502), the shipper registration device 321 registers the product information (step 506).

Then, the shipper registration device 321 notifies the shipper that the product has been registered (step S507).

The consumer registration device 322 accepts information about the consumer from the consumer and performs a consumer registration procedure to register the consumer.

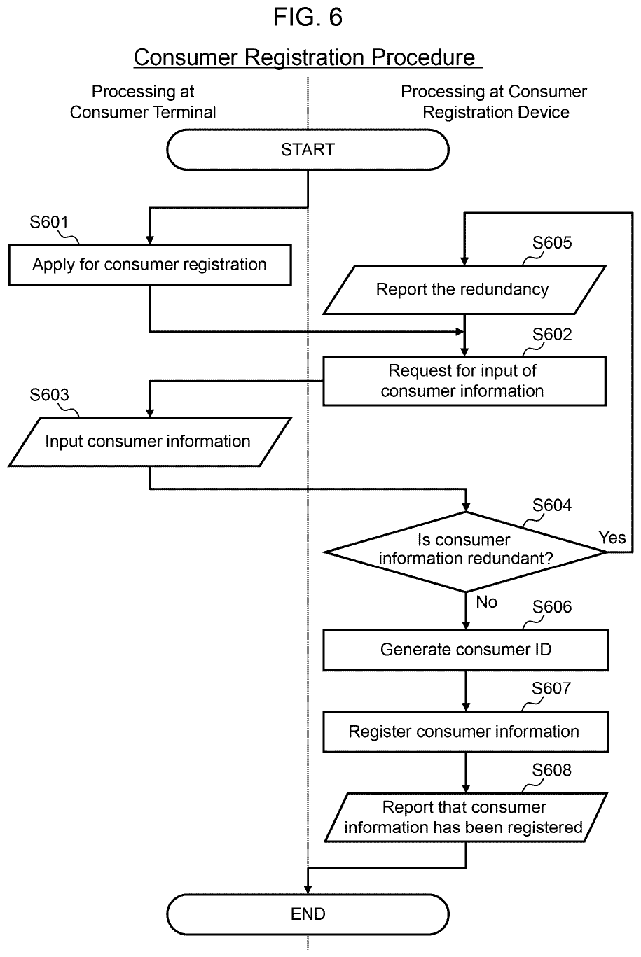

FIG. 6 is a flowchart illustrating the consumer registration procedure. Incidentally, FIG. 6 illustrates the flowchart separately for processing in the consumer terminal 20 and processing in the consumer registration device 322.

Firstly, the consumer applies for the consumer registration (step S601).

Next, the consumer registration device 322 requests the consumer to input consumer information (step S602).

In response to this request, the consumer inputs the consumer information (step S603). Values to be input by the consumer as the consumer information are, for example, the consumer name, their location, and business classification.

The consumer registration device 322 accepts the input consumer information and judges whether the consumer information is redundant or not (step S604). The consumer registration device 322 judges the redundancy of the consumer information based on the consumer name and their location. Specifically, if there is a match regarding both the consumer name and their location, the consumer registration device 322 recognizes the redundancy.

As a result, if the consumer information is redundant (Yes in step S604), the consumer registration device 322 notifies the consumer of the redundancy (step S605). Then, the processing returns to step S602.

On the other hand, if the consumer information is not redundant (No in step S604), the consumer registration device 322 generates a consumer ID (step S606). The consumer registration device 322 generates a unique value as the consumer ID.

Then, the consumer registration device 322 registers the consumer information (step S607). Furthermore, the consumer registration device 322 notifies the consumer that the consumer information has been registered (step S608).

When the shipper registers a product shipment schedule, the shipment schedule registration device 323 accepts a shipment schedule of a shipped item from the shipper and performs a shipment schedule registration procedure. This corresponds to 1 and 2 in FIG. 3.

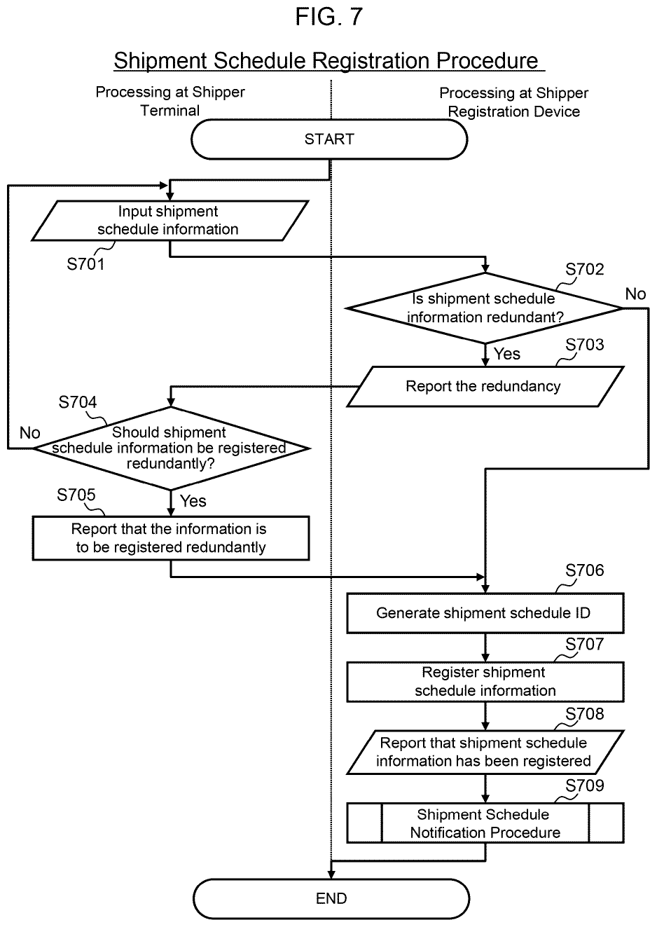

FIG. 7 is a flowchart illustrating the shipment schedule registration procedure. Incidentally, FIG. 7 illustrates the flowchart separately for processing in the shipper terminal 10 and processing in the shipment schedule registration device 323.

Firstly, the shipper inputs shipment schedule information (step S701). Values to be input by the shipper as the shipment schedule information are, for example, standards, a scheduled shipment quantity, a scheduled shipping date, a shipped item ID, and a shipping price.

Next, the shipment schedule registration device 323 accepts the input shipment schedule information and judges whether the shipment schedule information is redundant or not (step S702). The shipment schedule registration device 323 judges the redundancy of the shipment schedule information by checking if all the shipper ID, the product ID, the standards, the scheduled shipping date, and the shipping price match or not.

As a result, if the shipment schedule information is redundant (Yes in step S702), the shipment schedule registration device 323 notifies the shipper of the redundancy (step S703).

Having received the notice, the shipper judges whether or not to register the shipment schedule information redundantly (step S704).

As a result, if the shipment schedule information is not to be registered redundantly (No in step S704), the processing returns to step S701.

On the other hand, if the shipment schedule information is to be registered redundantly (Yes in step S704), the shipper reports that the shipment schedule information is to be registered redundantly (step S705).

If the shipment schedule information is not redundant after step S705 and in step S702 (No in step S702), the shipment schedule registration device 323 generates a shipment schedule ID (step S706). The shipment schedule registration device 323 generates a unique value as the shipment schedule ID.

Then, the shipment schedule registration device 323 registers the shipment schedule information (step S707).

Furthermore, the shipment schedule registration device 323 notifies the shipper that the shipment schedule information has been registered (step S708).

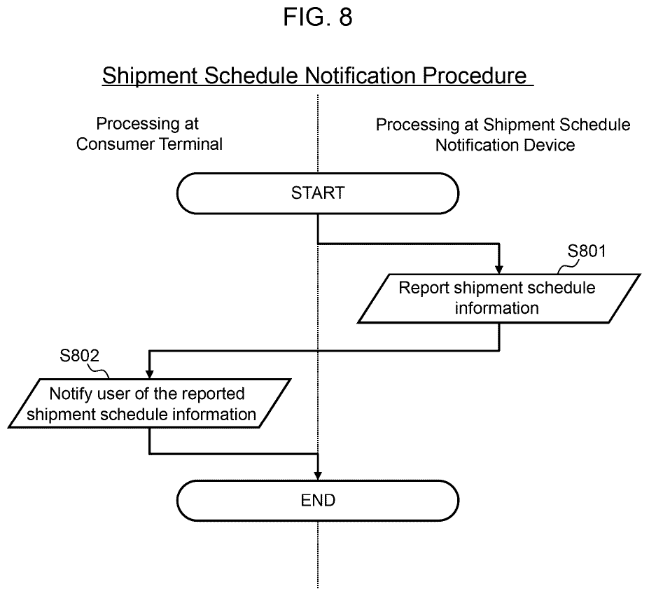

Then, the shipment schedule notification device 324 performs a product shipment schedule notification procedure (step S709). This will be explained next with reference to FIG. 8.

The shipment schedule notification device 324 performs the shipment schedule notification procedure to notify the consumer of the product shipment schedule. This corresponds to 3 in FIG. 3.

FIG. 8 is a flowchart illustrating the shipment schedule notification procedure. Incidentally, FIG. 8 illustrates the flowchart separately for processing in the consumer terminal 20 and processing in the shipment schedule notification device 324.

Firstly, the shipment schedule notification device 324 notifies the consumer of the shipment schedule information (step S801).

Next, the consumer terminal 20 notifies the user of the reported shipment schedule information (step S802). Possible means for notifying the user includes, for example, displaying the information on a display, e-mail transmission, and notification via an SNS (Social Networking Service) such as LINE (registered trademark). Incidentally, this processing may be performed by the shipment schedule notification device 324 without the intermediation of the consumer terminal 20.

The purchase application acceptance device 325 accepts the application for the purchase of the product from the consumer and performs a purchase application acceptance procedure. This corresponds to 4 in FIG. 3.

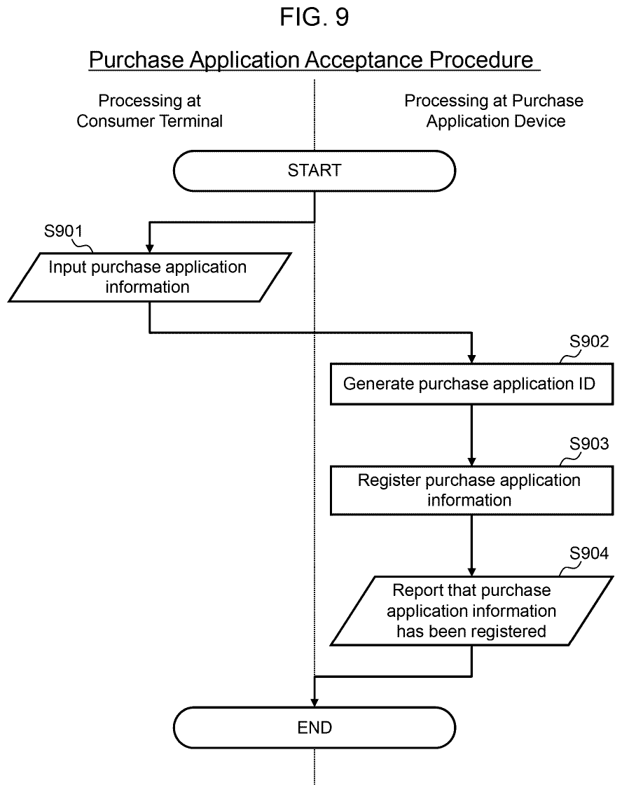

FIG. 9 is a flowchart illustrating the purchase application acceptance procedure. Incidentally, FIG. 9 illustrates the flowchart separately for processing in the consumer terminal 20 and processing in the purchase application acceptance device 325.

Firstly, the consumer inputs the purchase application information (step S901). Values to be input as the purchase application information are, for example, a consumer ID and a purchase application quantity as well as a shipment schedule ID, a product ID, standards, and a purchase application price.

Next, the purchase application acceptance device 325 accepts the input purchase application information and generates a purchase application ID (step S902). The purchase application acceptance device 325 generates a unique value as the purchase application ID.

Furthermore, the purchase application acceptance device 325 registers the purchase application information (step S903).

Then, the purchase application acceptance device 325 notifies the consumer that the purchase application information has been registered (step S904).

The production adjustment proposal device 32 performs a production type adjustment of the product. This corresponds to 5 in FIG. 3. The production type adjustment of the product will be described later in detail.

The purchase confirmation device 327 performs a purchase confirmation procedure to confirm the purchase of the product. This corresponds to 8 and 9 in FIG. 3.

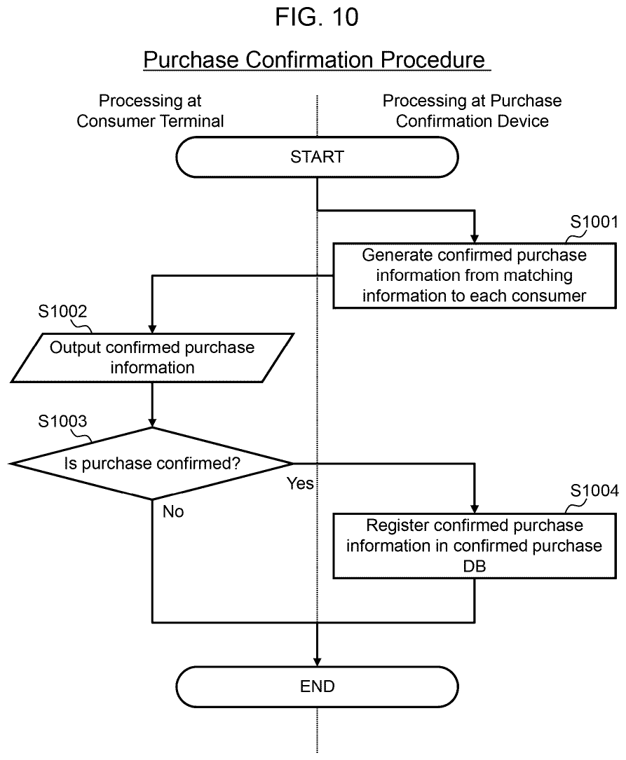

FIG. 10 is a flowchart illustrating the product purchase confirmation procedure. Incidentally, FIG. 10 illustrates the flowchart separately for processing in the consumer terminal 20 and processing in the purchase confirmation device 327.

Firstly, the purchase confirmation device 327 generates confirmed purchase information for each consumer from matching information which will be described later (step S1001). The confirmed purchase information is, for example, a pair of the purchase application ID and the confirmed shipment ID, which is combined with a purchase quantity, a purchase price, and a selling price. The purchase price is the price to be paid by the consumer side and the selling price is the price to be received by the shipper side.

Next, the consumer terminal 20 outputs the confirmed purchase information (step S1002). The consumer terminal 20 outputs, for example, a purchase quantity and a purchase price as the confirmed purchase information.

Then, with the consumer terminal 20, the user who saw the confirmed purchase information judges whether or not to confirm the purchase, and inputs the judgment result to the consumer terminal 20 (step S1003).

As a result, if the purchase confirmation is input (Yes in step S1003), the purchase confirmation device 327 registers the confirmed purchase information, which has been confirmed, in the confirmed purchase DB 346 (step S1004).

On the other hand, if the purchase confirmation is not input (No in step S1003), the confirmed purchase information is not registered in the confirmed purchase DB 346 and the processing terminates.

The sale-and-purchase matching device 328 performs a sale-and-purchase matching procedure to decide a delivery destination of the shipper's product. This corresponds to 7 in FIG. 3.

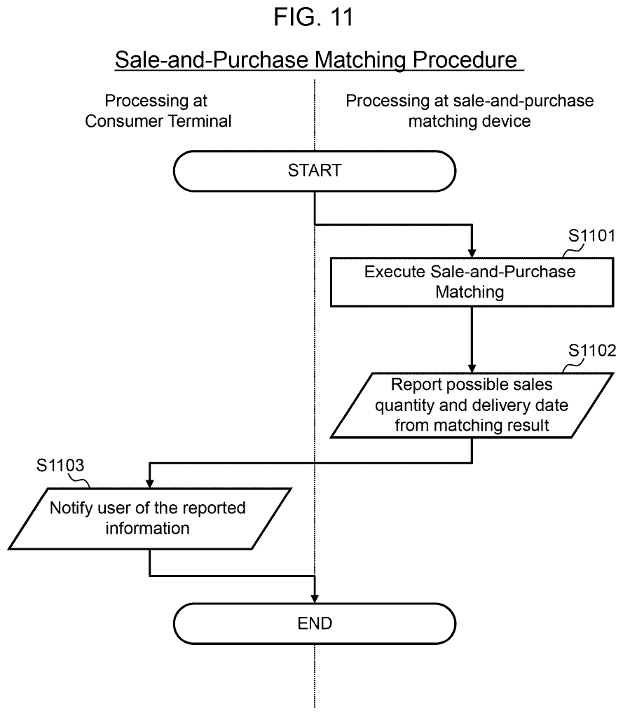

FIG. 11 is a flowchart illustrating operations of the sale-and-purchase matching device 328. Incidentally, FIG. 11 illustrates the flowchart separately for processing in the consumer terminal 20 and processing in the sale-and-purchase matching device 328.

Firstly, the sale-and-purchase matching device 328 executes sale-and-purchase matching (step S1101). The sale-and-purchase matching will be described later in detail.

Next, the sale-and-purchase matching device 328 notifies the consumer of a possible sales volume and a delivery date from the matching result (step S1102).

Then, the consumer terminal 20 receives the notice and notifies the user of the reported information (step S1103).

The settlement-and-logistics processing device 329 performs settlement processing and logistics processing. This corresponds to 10 in FIG. 3.

Upon shipping the product, the logistics prediction device 330 predicts a cost required for logistics and a delivery period.

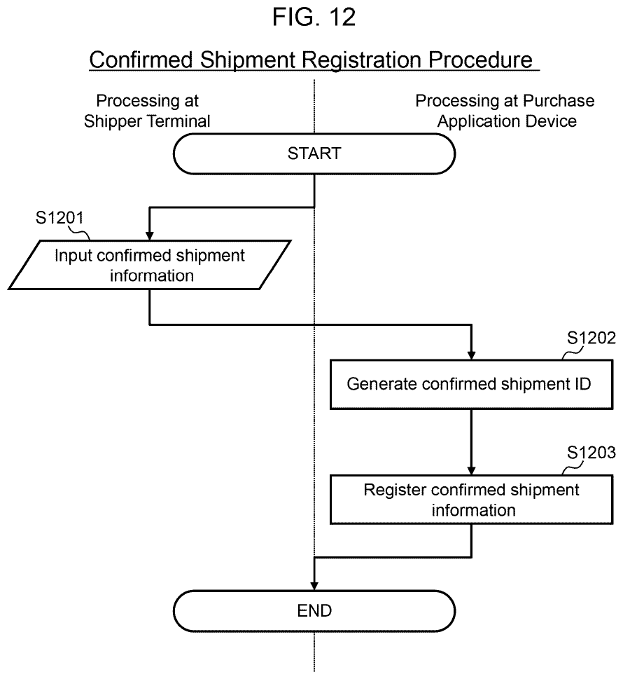

The confirmed shipment registration device 331 performs a confirmed shipment registration procedure to register shipment confirmation of the product. This corresponds to 6 in FIG. 3. FIG. 12 is a flowchart illustrating the confirmed shipment registration procedure. Incidentally, FIG. 12 illustrates the flowchart separately for processing in the shipper terminal 10 and processing in the confirmed shipment registration device 331.

Firstly, the shipper terminal 10 inputs confirmed shipment information (step S1201). Values to be input as the confirmed shipment information are, for example, a shipment schedule ID and confirmed shipment quantity of the relevant shipment schedule as well as a confirmed shipping date.

Next, the confirmed shipment registration device 331 generates a confirmed shipment ID (step S1202). The confirmed shipment registration device 331 generates a unique value as the confirmed shipment ID.

Then, the confirmed shipment registration device 331 registers the confirmed shipment information (step S1203).

The storage unit 34 includes a shipper DB 341, a consumer DB 342, a shipment schedule DB 343, a confirmed shipment DB 344, a purchase application DB 345, a confirmed purchase DB 346, a product DB 347, and a logistics DB 348. Incidentally, these are separate DBs (databases), but they may be saved in the same storage as long as they are logically divided.

The shipper DB 341 is to save the shipper information registered by the shipper registration device 321.

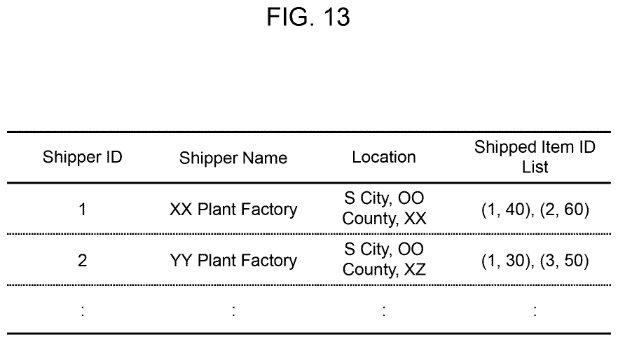

FIG. 13 is a diagram illustrating the shipper information saved in the shipper DB 341.

The shipper information shown as an example here is composed of a shipper ID, a shipper name, a location, and a shipped item ID list.

The shipper ID is referenced within the product shipping system 1. Accordingly, a unique value within the product shipping system 1 is required. The shipper ID can be a serial number or a UUID (Universally Unique Identifier).

The shipper name is the shipper's name and, for example, a company name, a farm name, or a plant factory name is applicable. The shipper name is used for various kinds of indications and an indication of origin for the consumer.

The location is the shipper's location. The location is used for the sale-and-purchase matching.

The shipped item ID list is a list of sets of the product ID and lead time of the relevant product. Here, the lead time is indicated as the number of days. The shipped item ID list is used for the production type adjustment.

The consumer DB 342 is to save the consumer information registered by the consumer registration device 322.

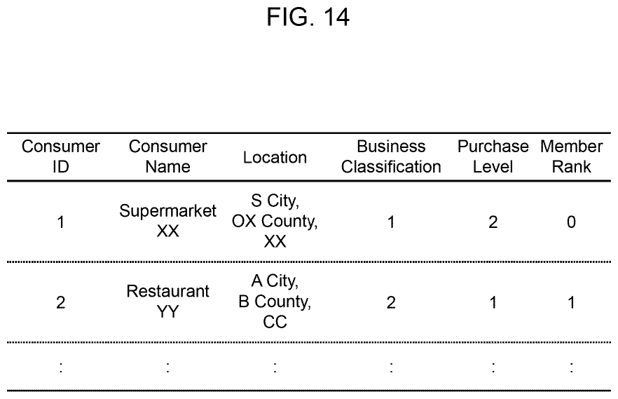

FIG. 14 is a diagram illustrating the consumer information saved in the consumer DB 342. The consumer information shown as an example here is composed of the consumer ID, the consumer name, the location, business classification, a purchase level, and a member rank.

The consumer ID is referenced within the product shipping system 1. Accordingly, a unique value within the product shipping system 1 is required. The consumer ID can be a serial number or a UUID.

The consumer name is the consumer's name and, for example, a company name, a retail store name, or an individual's name is applicable. The consumer name is used for the settlement and logistics processing.

The location is the consumer's location. The location is used for the sale-and-purchase matching.

The business classification is an ID for classifying retailing, eating-out, etc. If the consumer is an individual, the ID for classifying the individual is assigned.

The purchase level represents the size of the product consumption quantity. As the numerical value of the purchase level becomes larger, the product consumption quantity becomes larger. Incidentally, the purchase level becomes the lowest level immediately after the registration of the consumer.

The member rank is the consumer's rank. The member rank comprises whether the member has a membership or not. Free members may be required to pay a shipping fee; and free shipping may be offered for paid members. The numerical values of the member rank have, for example, the following meanings.

Rank 0=non-member

Rank 1=high-level member with high annual membership fee

Rank 2=medium-level member with low annual membership fee

Rank 3=member without annual membership fee

If the consumer becomes the high-level member, they can receive various kinds of services such as preferential purchase rights. As the various kinds of services, for example, cultivation plot sales of plant factory vegetables, farming experience, and volunteer participation are applicable. Incidentally, the member rank immediately after the registration of the consumer is the non-member.

Incidentally, as the consumer information, for example, a mechanism of letting the consumer input their comment and making the shipper receive this comment anonymously or with their name may be incorporated.

The shipment schedule DB 343 is to save the shipment schedule information registered by the shipment schedule registration device 323. The shipment schedule information is the scheduled information of the product shipment as explained earlier.

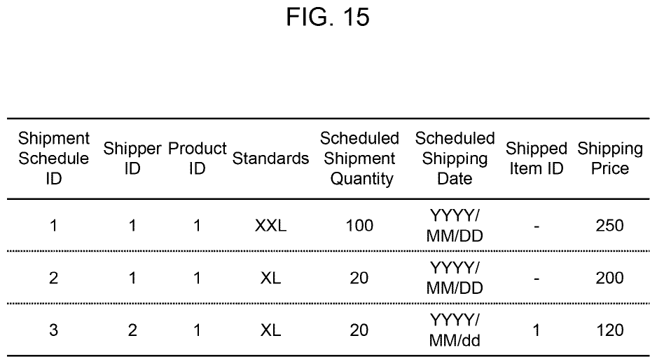

FIG. 15 is a diagram illustrating the shipment schedule information saved in the shipment schedule DB 343.

The shipment schedule information shown here as an example is composed of a shipment schedule ID, a shipper ID, a product ID, standards, a scheduled shipment quantity, a scheduled shipping date, a shipped item ID, and a shipping price.

The shipment schedule ID is an ID assigned to each piece of the shipment schedule information and is used to identify each piece of the shipment schedule information.

The shipper ID is the same one as the shipper ID included in the shipper information saved in the shipper DB 341 and is used to be linked to the content of the shipper DB 341.

The product ID is an ID assigned to each production type of the product and is the ID for classifying the relevant product.

The standards are specified for each product ID and are a character string indicating the standards. Here, the standards are decided according to the size of the product.

The scheduled shipment quantity is a quantity of the product scheduled to be shipped. Here, the scheduled shipment quantity is expressed by the weight (kg) of the product.

The scheduled shipping date is a scheduled date to ship the product.

The shipped item ID is used when identifying an outlet product. In a case of the outlet product, “1” is set. If the product is to be shipped from, for example, the open-field cultivation or the plant factory, the shipped item ID is a value which can distinguish between the open-field cultivation and the plant factory. In the example shown in this drawing, “−” is indicated. The shipping price is a price of the product per unit weight. The meaning of the shipping price changes depending on who bears a logistics cost. If the shipper side bears the logistics cost, the shipping price includes the logistics cost and is identical to the consumer's purchase price. If the consumer side also bears the logistics cost, a proper logistics cost can be decided after the sale-and-purchase matching and the shipping price is not identical to the consumer's purchase price.

The confirmed shipment DB 344 is to save the confirmed shipment information registered by the confirmed shipment registration device 331. The confirmed shipment information is confirmed information about the product shipment when the product produced by the shipper including the plant factory is to be shipped to the delivery destination as described earlier.

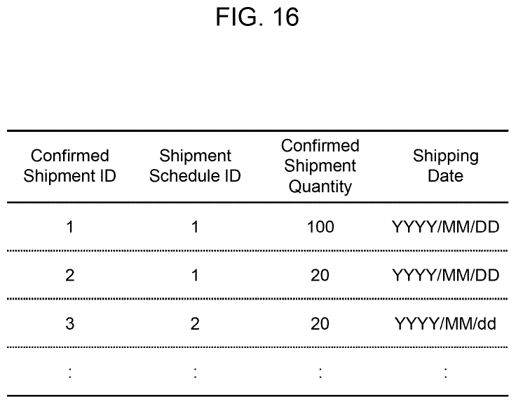

### FIG. 16 is a diagram illustrating the confirmed shipment information saved in the confirmed shipment DB 344.

The confirmed shipment information shown here as an example is composed of a confirmed shipment ID, a shipment schedule ID, a confirmed shipment quantity, and a shipping date.

The confirmed shipment ID is an ID assigned to each piece of the confirmed shipment information and is used to identify each piece of the confirmed shipment information.

The shipment schedule ID is the same one as the shipment schedule ID included in the shipment schedule information saved in the shipment schedule DB 343 and is used to be linked to the content of the shipment schedule DB 343.

The confirmed shipment quantity is a quantity of the product whose shipment is confirmed. Here, the confirmed shipment quantity is expressed by the weight (kg) of the product.

The shipping date is the date when the product whose shipment is confirmed will be shipped.

The purchase application DB 345 is to save the purchase application information registered by the purchase application acceptance device 325. The purchase application information is information of an application for the purchase of the product by the delivery destination as described earlier.

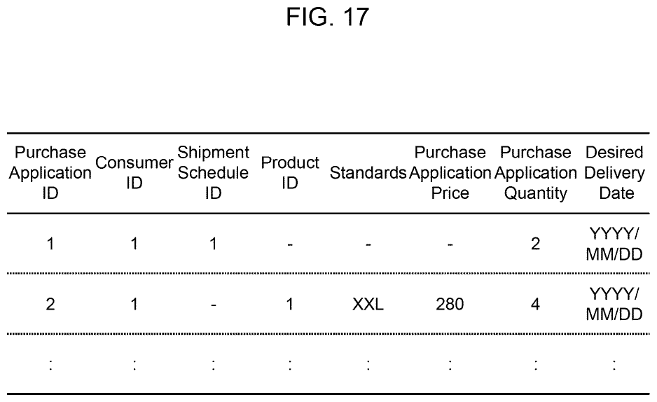

FIG. 17 is a diagram illustrating the purchase application information saved in the purchase application DB 345.

The purchase application information shown here as an example is composed of a purchase application ID, a consumer ID, a shipment schedule ID, a product ID, standards, a purchase application price, a purchase application quantity, and a desired delivery date.

The purchase application ID is an ID assigned to each piece of the purchase application information and is used to identify each piece of the purchase application information.

The consumer ID is the same one as the consumer ID of the consumer information saved in the consumer DB 342 and is used to be linked to the content of the consumer DB 342. The shipment schedule ID is used when directly making the purchase application with respect to the shipment schedule. In this case, “1” is set. On the other hand, when making the purchase application by designating the product ID, the standards, and the purchase application price, a special value is used. In the above-mentioned example, “−” is the special value.

The product ID, the standards, and the purchase application price are not designated with respect to the shipment schedule, but they are used when making the purchase application by designating the product. In this case, “1” is set. On the other hand, when making the purchase application by designating the shipment schedule ID, a special value is used. In the above-mentioned example, “−” is the special value. When accepting the purchase application with a rough specification without designating any detailed variety, a special value may possibly be assigned as the product ID. For example, a value which is assigned when any variety is acceptable as long as the product is rice may be the special value.

The purchase application quantity is a quantity of the product regarding which the purchase application is made. Here, the purchase application quantity is expressed by the weight (kg) of the product.

The desired delivery date is a desired date when the product should be delivered to the consumer. In a case of the purchase application by the shipment schedule ID, it is used when sending a notice of delayed delivery. In a case of the purchase application by designating the product, the shipment schedule is targeted so that the product can be delivered around the desired delivery date.

The confirmed purchase DB 346 is to save the confirmed purchase information registered by the production adjustment proposal device 326.

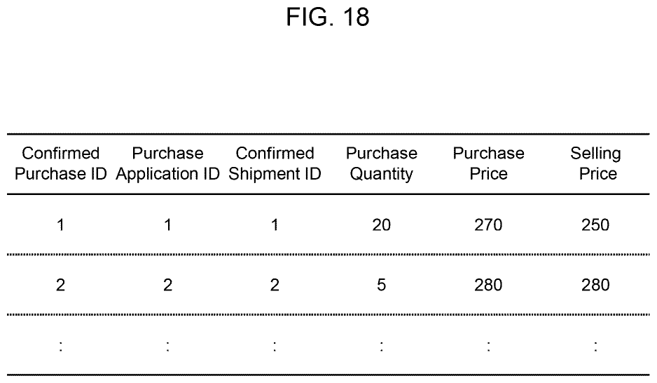

FIG. 18 is a diagram illustrating the confirmed purchase information saved in the confirmed purchase DB 346.

The confirmed purchase information shown here as an example is composed of a confirmed purchase ID, a purchase application ID, a confirmed shipment ID, a purchase quantity, a purchase price, and a selling price.

The confirmed purchase ID is an ID assigned to each piece of the confirmed purchase information and is used to identify each piece of the confirmed purchase information.

The purchase application ID is the same one as the purchase application ID included in the purchase application information which is saved in the purchase application DB 345, and is used to be linked to the content of the purchase application DB 345.

The confirmed shipment ID is the same one as the confirmed shipment ID included in the confirmed shipment information which is saved in the confirmed shipment DB 344, and is used to be linked to the content of the confirmed shipment DB 344.

The purchase quantity is a quantity of the product whose purchase is confirmed. Here, the purchase quantity is expressed by the weight (kg) of the product.

The purchase price is a price of the product per unit weight to be purchased by the consumer.

The selling price is a price of the product per unit weight to be shipped by the shipper. There is a possibility as explained earlier that the difference may occur between the purchase price and the selling price, depending on who bears the logistics cost.

The product DB 347 is to save the product information registered by the shipper registration device 321.

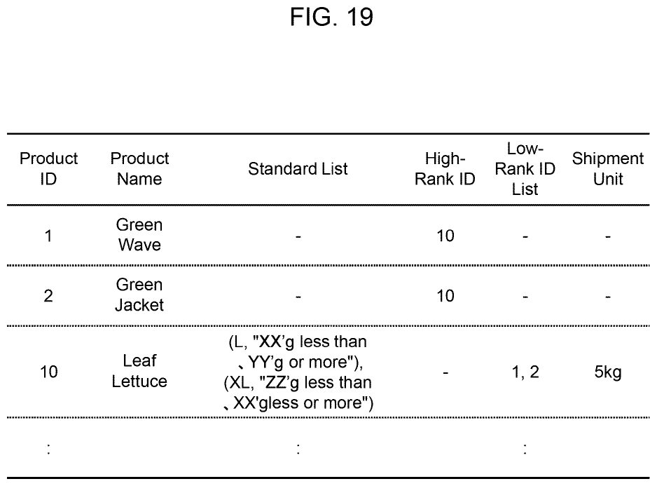

FIG. 19 is a diagram illustrating the product information saved in the product DB 347.

The product information shown here as an example is composed of a product ID, a product name, a standard list, a high-rank ID, a low-rank ID list, and a shipment unit.

The product ID is an ID assigned to each piece of the product information and is used to identify each piece of the product information.

The product name is the name of the product. The product name is used to indicate it for the shipper and the consumer.

The standard list is a list of sets of the standard name and the standard definition. The standard list of a product without the low-rank ID should be empty. In the example shown in the drawing, it is indicated as “−.”

The high-rank ID or the low-rank ID is selected when it is desired to purchase the product not by designating any specific variety, but by designating rough classification. The Green Wave and Green Jacket mentioned in the example in the drawing are variety names of leaf lettuce. They are used as classification criteria in order to put together products with properties close enough to apply the same standard list.

The shipment unit is a packing unit when shipping the product.

An ID for distinguishing between a product of the plant factory and a product of the open-field cultivation may be assigned as the product information. When notifying the consumer of the product shipment schedule, it can be used to indicate the product as a branded item.

The logistics DB 348 is to save logistics route information predicted by the logistics prediction device 330.

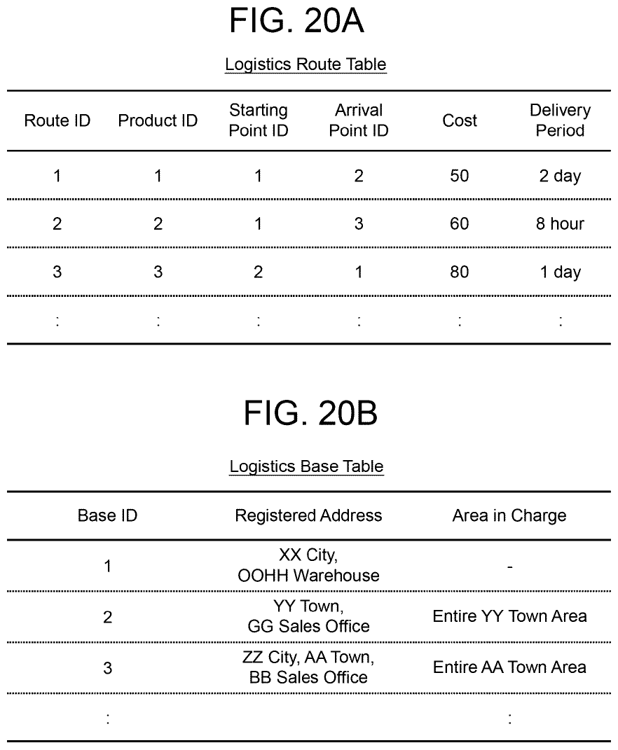

FIG. 20(a) and (b) are diagrams illustrating the logistics route information saved in the logistics DB 348.

The logistics route information shown here as an example is composed of a logistics route table shown in FIG. 20(a) and a logistics base table shown in FIG. 20(b). The logistics route table is a table to indicate a cost and a delivery period with respect to a plurality of logistics routes. Moreover, the logistics base table is a table to indicate information about logistics bases.

The logistics route table shown in FIG. 20(a) is composed of a route ID, a product ID, a starting point ID, an arrival point ID, a cost, and a delivery period.

The route ID is an ID assigned to each logistics route and is used to identify each logistics route.

The product ID is a product ID for a product to be handled in a logistics route. Assuming that it may be required to handle respective products differently, different products are handled as having different routes even though their starting points and arrival points are the same in the logistics route table.

The starting point ID and the arrival point ID designate the starting point and the arrival point in the relevant logistics route, respectively. Their respective IDs refer to the information based on the base IDs in the logistics base table.

The cost is logistics expenses per shipment unit of the product regarding each logistics route. It is the logistics cost per shipment unit designated by the product ID.

The delivery period is a delivery period required when using each logistics route.

The logistics base table shown in FIG. 20(b) is composed of a base ID, a registered address, and an area in charge.

The base ID is an ID assigned to each logistics base and is used to identify each logistics base.

The registered address is a representative address of each logistics base. It is used for a UI (User Interface) regarding traceability.

The area in charge is an area designated for each logistics base to take charge of collecting and delivering products. If only relaying is to be conducted, for example, when the logistics base is a warehouse, no area in charge is set.

### <Detailed Description of Production Type Adjustment of Product>

Next, the production type adjustment of the product which is performed by the production adjustment proposal device 326 and corresponds to 5 in FIG. 3 will be described in detail.

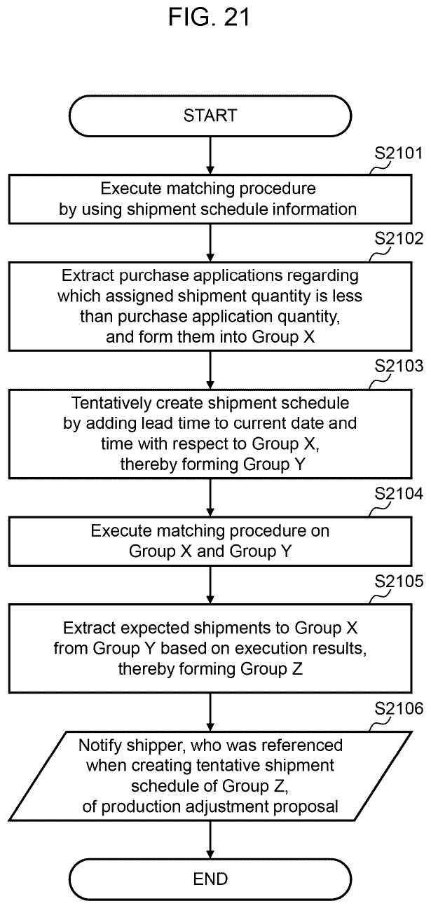

FIG. 21 is a flowchart for explaining the production type adjustment of the product, which is performed with respect to the plant factory/factories.

Firstly, the processing unit 32 executes matching procedure by using the shipment schedule information (step S2101).

Next, the processing unit 32 extracts, from among purchase applications, those regarding which their assigned shipment quantity is less than the purchase application quantity, by using the purchase application information and forms the extracted purchase applications into Group X (step S2102).

Next, the processing unit 32 tentatively creates a shipment schedule by adding the lead time to a current date and time of Group X, thereby forming Group Y(step S2103).

Then, the processing unit 32 executes the matching procedure on Group X and Group Y (step S2104).

Furthermore, the processing unit 32 extracts an estimated shipment to Group X from Group Y based on the execution result of the matching procedure, thereby forming Group Z (step S2105).

Furthermore, the processing unit 32 notifies the shipper, who was referenced when creating the tentative shipment schedule for Group Z, of a production adjustment proposal (step S2106).

Accordingly, the processing unit 32 proposes the adjustment of the type of the product to be produced by the plant factory based on the shipment schedule information and the purchase application information. Under this circumstance, the processing unit 32 proposes the adjustment of the type of the product to be produced by the plant factory by performing the matching procedure for making the shipment schedule information and the purchase application information match each other. The matching procedure is performed based on predetermined optimization criteria. The optimization criteria need to be given from the outside and be decided in advance. In this embodiment, criteria relating to the logistics of products are set as the optimization criteria. Consequently, optimization is implemented in consideration of the logistics of the products. When deciding the optimization criteria, maximizing the supply of the relevant product, prioritizing the order of supply according to the rank of the delivery destination, reducing the cost of transportation according to the transportation distance, preventing deterioration of the freshness due to transportation duration, minimizing transportation time, and so on can be considered.

The matching procedure performed for the production type adjustment of the product is processing, as a result of the matching between the shipment schedule information and the purchase application information according to the optimization criteria (step S2101), tentatively creating the quantity of the product to be shipped by the plant factory (step S2103), and causing the shipment schedule information, which has been corrected by incorporating the tentatively shipment schedule, and the purchase application information to match each other (step S2104). Specifically speaking, when the processing unit 32 performs the production type adjustment of the product, the processing unit 32 performs the matching procedure twice in step S2101 and step S2104. Consequently, the production adjustment is proposed by also estimating the quantity of the product to be shipped after the production adjustment.

### <Detailed Description of Matching Processing>

Next, an explanation will be provided about further details of the above-described matching processing which is performed in 5 in FIG. 3 and is explained with reference to FIG. 21, and the matching processing used for the sale-and-purchase matching explained regarding 7 in FIG. 3. In the matching procedure performed in 5 in FIG. 3, the matching processing is performed in order to adjust the production type of the product. In the sale-and-purchase matching performed in 7 in FIG. 3, the matching processing is performed in order to decide the delivery destination of the product. Here, an explanation will be provided by taking the sale-and-purchase matching of the latter case as an example.

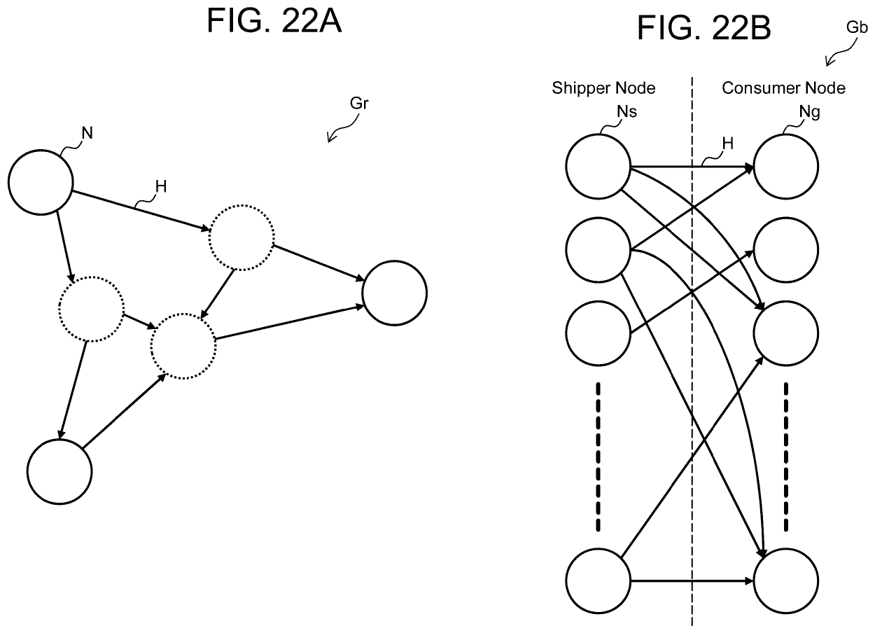

FIG. 22(a) and (b) are diagrams for explaining the sale-and-purchase matching.

Of these diagrams, FIG. 22(a) is a diagram illustrating a logistics graph Gr created as a preliminary stage when performing the sale-and-purchase matching.

The logistics graph Gr shown in this diagram is obtained by organizing, for example, costs related to logistics and a required number of days in a graph form. The logistics graph Gr is a directed graph whose respective edges have directions and which is constructed for each product ID. Therefore, generally, the logistics graph Gr varies for each product and the logistics graph Gr is created for each product. In the logistics graph Gr shown in the diagram, a node N expressed as a circle corresponds to each logistics base. Of these circles, a solid-line circle corresponds to a logistics base having an area in charge and a broken-line circle corresponds to a logistics base having no area in charge. Then, a directed edge H indicated with an arrow corresponds to each logistics route. A starting source of the arrow is a logistics base designated with the starting point ID and a destination which the arrow enters is a logistics base designated with the arrival point ID.

The construction of the logistics graph Gr is performed in the following procedures (1) to (3).

(1) All the logistics bases are registered as nodes N.

(2) The directed edge(s) H corresponding to the logistics route information having the product ID designated upon the construction is registered.

(3) The node(s) N which is not connected to any edge is deleted.

Moreover, FIG. 22(b) is a diagram illustrating a sale-and-purchase match graph Gb which is used when performing the sale-and-purchase matching.

The sale-and-purchase match graph Gb is a bipartite graph composed of shipper nodes Ns and consumer nodes Ng. In FIG. 22(b), the shipper nodes Ns are placed on the left side and the consumer nodes Ng are placed on the right side. The shipper nodes Ns correspond to the confirmed shipment information. The consumer nodes correspond to the purchase application information. All the edges are the directed edges H, each of which extends from any one of the shipper nodes Ns to any one of the consumer nodes Ng. The respective directed edges H which do not become Pareto inferior regarding the optimization criteria to be considered, from among available logistics paths, are listed. This can be also described as selecting the edges according to the optimization criteria as those which do not become Pareto inferior, in the logistics graph Gr in which the logistics bases are linked to each other with the directed edges H corresponding to the logistics routes, and using such selected directed edges H for the sale-and-purchase match graph Gb.

Therefore, what is considered here is a Pareto optimal solution regarding the logistics routes. The Pareto optimal solution can be found by existing methods. The Pareto optimal solution can be found by, for example, full search. Moreover, the Pareto optimal solution can be found by, for example, using an MIP (Mixed Integer Programming problem) solver. The sale-and-purchase match graph Gb may not necessarily become a simple graph, but there may possibly exist a plurality of delivery routes which become Pareto optimal. The cost according to the optimization criteria is set to the directed edges H. For example, it is possible to set the cost (logistics cost) in FIG. 20(a). Moreover, it is also possible to further set the delivery period in FIG. 20(a). This is naturally induced from the Pareto optimal route in the logistics graph Gr. The sale-and-purchase matching is executed by solving a multi-commodity minimum cost flow problem based on the sale-and-purchase match graph Gb.

In the above-described sale-and-purchase matching, the confirmed shipment information and the purchase application information are caused to match each other in order of priority based on the predetermined optimization criteria. Consequently, since priority matching can be performed based on the supply of the product, the type of the consumer, and the member rank, optimal distribution can be made to the consumer, including the product of the plant factory. As the food will be supplied stably by the plant factory and the product will then approach a sold-out state, this will contribute to the profit improvement of an operator of the plant factory.

Moreover, the sale-and-purchase matching is performed by using the sale-and-purchase match graph Gb which is determined for each product and in which the shipper nodes Ns determined by the confirmed shipment information and the consumer nodes Ng determined by the purchase application information are linked together with the directed edges H corresponding to the logistics routes. As the sale-and-purchase match graph Gb, for which the logistics are considered, is used and the sale-and-purchase match graph Gb are set as constraint conditions, the amount of computation required for multi-objective optimization such as the supply of the product, the situation of the consumer, and transportation can be reduced, and the matching between the plurality of shippers and the plurality of consumers can be made more efficient.

Incidentally, the sale-and-purchase matching can implement the matching so as not to exceed that the allowable shipping fee which is the upper limit of the shipping fee.

The sale-and-purchase match graph Gb can be created for each rank (the member rank) that is set to the delivery destination in advance. Specifically speaking, the product is shipped preferentially to a high-ranking consumer who has, for example, a large consumption quantity. Consequently, it is possible to further improve the facility operating rate of the plant factory and reduce the disposal of the product.

A method similar to this method is used when performing the matching processing in order to conduct the production type adjustment of the product. However, the difference is that regarding the information to be used, the shipper nodes Ns correspond to the shipment schedule information, but not to the confirmed shipment information.

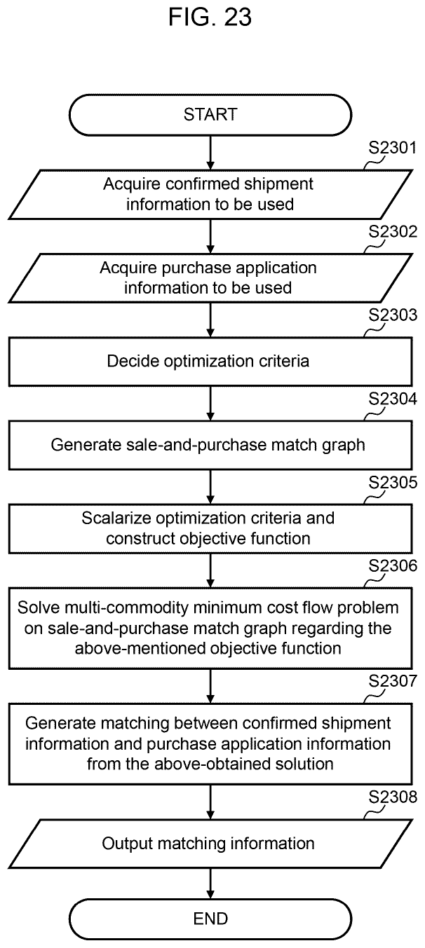

FIG. 23 is a flowchart for explaining further details of operations of the sale-and-purchase matching device 328 when performing the above-described matching processing. FIG. 23 is the flowchart which explains further details of step S1101 in FIG. 11.

Firstly, the sale-and-purchase matching device 328 acquires the confirmed shipment information to be used (step S2301). This is shown as an example in FIG. 16.

Next, the sale-and-purchase matching device 328 acquires the purchase application information to be used (step S2302). This is shown as an example in FIG. 17.

Then, the sale-and-purchase matching device 328 decides the optimization criteria (step S2303).

Subsequently, the sale-and-purchase matching device 328 generates the sale-and-purchase match graph Gb (step S2304). This is shown as an example in FIG. 22(b).

Moreover, the sale-and-purchase matching device 328 scalarizes the optimization criteria and constructs an objective function (step S2305). The scalarization is to integrate evaluation values of the respective optimization criteria to form one evaluation value. The scalarization can be conducted by publicly-known methods. For example, the scalarization can be conducted by using a linear combination of the respective evaluation values as a relatively easy method.

Furthermore, the sale-and-purchase matching device 328 solves the multi-commodity minimum cost flow problem in the sale-and-purchase match graph Gb with respect to the constructed objective function (step S2306). Accordingly, the sale-and-purchase matching can be also described as the processing for scalarizing the optimization criteria to create the objective function and solving the multi-commodity minimum cost flow problem in the sale-and-purchase match graph Gb with respect to the created objective function.

Furthermore, the sale-and-purchase matching device 328 generates the matching between the confirmed shipment information and the purchase application information from the above-described solution (step S2307).

Then, the sale-and-purchase matching device 328 outputs matching information as information of the matching (step S2308).

Which product and how many of them were transported on each directed edge H is found as a solution of the multi-commodity minimum cost flow problem. Since the sale-and-purchase match graph Gb is a bipartite graph in which the shipper nodes Ns and the consumer nodes Ng are placed separately, a transportation quantity on the directed edge H directly indicates how many products should be allocated from which shipper to which purchase application. The matching information takes the same format as that of the confirmed purchase information.

A method similar to this method is also used when performing the matching processing in order to conduct the production type adjustment of the product. However, the difference is that the information to be used corresponds to the shipment schedule information, but not the confirmed shipment information.

If the information processing device 30 and the product shipping system 1 which have been described above are employed, it is possible to improve the facility operating rate of the plant factories and reduce the disposal of the product when the plant factories are included as the shippers.

### <Description of Information Processing Method>

The processing performed by the above-described information processing device 30 is implemented by cooperation between software and hardware resources. Specifically speaking, a processor inside a computer provided in the information processing device 30 loads the software for implementing the aforementioned respective functions to a memory and executes it, thereby implementing these respective functions.

Therefore, the processing performed by the information processing device 30 can be recognized as an information processing method including the following, by execution of the software recorded in the memory by the processor: accepting, when shipping a product produced by a shipper including a plant factory to a delivery destination, confirmed shipment information which is confirmed information about shipment of the product, and purchase application information which is information of an application for purchase of the product by the delivery destination; and deciding the delivery destination of the product by performing sale-and-purchase matching, based on predetermined optimization criteria, to make the confirmed shipment information and the purchase application information match each other in order of priority.

This embodiment has been described above, but the technical scope of the present invention is not limited to the scope described in the above-described embodiment. It is obvious from the description of the scope of patent claims that the above-described embodiment with various changes or improvements added thereto is also included within the technical scope of the present invention.

### REFERENCE SIGNS LIST

1: product shipping system

10: shipper terminal

20: consumer terminal

30: information processing device

31: input/output device

32: processing unit

34: storage unit

N: node

Ns: shipper node

Ng: consumer node

H: directed edge

Gr: logistics graph

Gb: sale-and-purchase match graph

1. An information processing system comprising:
an acceptance unit that accepts, when shipping a product produced by a shipper including a plant factory to a delivery destination, confirmed shipment information which is confirmed information about shipment of the product, and purchase application information which is information of an application for purchase of the product by the delivery destination; and
a processing unit that decides the delivery destination of the product by performing sale-and-purchase matching, based on predetermined optimization criteria, to make the confirmed shipment information and the purchase application information match each other in order of priority.

2. The information processing system according to claim 1,
wherein the sale-and-purchase matching is decided for each product and is performed by using a sale-and-purchase match graph which couples a shipper node decided by the confirmed shipment information and a consumer node decided by the purchase application information with a directed edge corresponding to a logistics route.

3. The information processing system according to claim 2,
wherein the sale-and-purchase matching is processing for solving a multi-commodity minimum cost flow problem based on the sale-and-purchase match graph.

4. The information processing system according to claim 3,
wherein the sale-and-purchase matching is processing for scalarizing the optimization criteria to create an objective function and solving the multi-commodity minimum cost flow problem on the sale-and-purchase match graph with respect to the created objective function.

5. The information processing system according to claim 3,
wherein the sale-and-purchase match graph is created for each preset rank with respect to the delivery destination.

6. The information processing system according to claim 2,
wherein an edge selected based on the optimization criteria, as one which does not become Pareto inferior, in a logistics graph formed by coupling logistics bases with a directed edge corresponding to a logistics route is used as the directed edge to be used in the sale-and-purchase match graph.

7. The information processing system according to claim 6,
wherein the directed edge of the logistics graph represents information about the logistics route.

8. The information processing system according to claim 2,
wherein the sale-and-purchase matching is performed to implement matching so as not to exceed an allowable shipping fee which is an upper limit of a shipping fee.

9. The information processing system according to claim 1,
wherein the processing unit proposes adjustment of a type of the product produced at the plant factory based on shipment schedule information which is scheduled information about shipment of the product and the purchase application information.

10. The information processing system according to claim 9,
wherein the processing unit proposes the adjustment of the type of the product produced at the plant factory by performing a matching procedure to cause matching based on the shipment schedule information and the purchase application information based on the optimization criteria.

11. The information processing system according to claim 10,
wherein the matching procedure is processing for tentatively creating a quantity of the product to be shipped by the plant factory based on a result of the matching between the shipment schedule information and the purchase application information and making the shipment schedule information, which has been corrected by incorporating the tentatively created shipment schedule, and the purchase application information match each other.

12. The information processing system according to claim 1,
wherein criteria relating to logistics of the product are set as the optimization criteria.

13. The information processing system according to claim 1,
wherein the shipper includes an outlet distributor.

14. An information processing method comprising the following, by execution of software recorded in a memory by a processor:
accepting, when shipping a product produced by a shipper including a plant factory to a delivery destination, confirmed shipment information which is confirmed information about shipment of the product, and purchase application information which is information of an application for purchase of the product by the delivery destination; and
deciding the delivery destination of the product by performing sale-and-purchase matching, based on predetermined optimization criteria, to make the confirmed shipment information and the purchase application information match each other in order of priority.

15. A product shipping system comprising:
a first terminal device to which a shipper including a plant factory inputs information about a product when shipping the product produced by the shipper to a delivery destination;
a second terminal device to which the delivery destination inputs purchase application information that is information of an application for purchase of the product; and
an information processing system that decides the delivery destination of the product produced by the shipper,
wherein the information processing system includes:
an acceptance unit that accepts confirmed shipment information which is confirmed information about shipment of the product, and the purchase application information; and
a processing unit that decides the delivery destination of the product by performing sale-and-purchase matching, based on predetermined optimization criteria, to make the confirmed shipment information and the purchase application information match each other.
